(19) United States
(12) Patent Application Publication
(10) Pub. No.: US 2014/0258219 A1
(43) Pub. Date: Sep. 11, 2014

(54) SYSTEM AND METHOD FOR PROVIDING RECOMMENDATIONS TO USERS BASED ON THEIR RESPECTIVE PROFILES

(71) Applicant: Cortica, Ltd., Ramat Gan (IL)

(72) Inventors: Igal Raichelgauz, New-York, NY (US); Karina Odinaev, New-York, NY (US); Yehoshua Y. Zeevi, Haifa (IL)

(73) Assignee: CORTICA, LTD., RAMAT GAN (IL)

(21) Appl. No.: 14/280,928

(22) Filed: May 19, 2014

Related U.S. Application Data
(63) Continuation-in-part of application No. 13/856,201, filed on Apr. 3, 2013.
Application No. 13/856,201 is a continuation-in-part of application No. 13/624,397, filed on Sep. 21, 2012.
Application No. 13/624,397 is a continuation-in-part of application No. 13/344,400, filed on Jan. 5, 2012.
Application No. 13/344,400 is a continuation-in-part of application No. 12/195,863, filed on Aug. 21, 2008, now Pat. No. 8,326,775.
Application No. 12/195,863 is a continuation-in-part of application No. 12/084,150, filed on Apr. 7, 2009, now Pat. No. 8,655,801.
Application No. 13/624,397 is a continuation-in-part of application No. 12/084,150, filed on Apr. 7, 2009, now Pat. No. 8,655,801.
(60) Provisional application No. 61/833,028, filed on Jun. 10, 2013.
(60) Provisional application No. 61/766,016, filed on Feb. 18, 2013.

(30) Foreign Application Priority Data
Aug. 21, 2007 (IL) 185414

(51) Int. Cl. G06F 17/30

(52) U.S. Cl. CPC G06F 17/30029
USPC 707/609; 707/770; 707/722; 707/737

(57) ABSTRACT

A method and system for providing recommendations to multimedia content elements of interest to a user. The method comprises receiving at least one multimedia content element; generating at least one signature for the received multimedia content element; querying a user profile of the user to determine a user interest; searching, by means of the at least one generated signature, through a plurality of data sources for multimedia content elements matching the determined user interest; and returning the matching multimedia content elements to the user node as recommendations.

### CROSS-REFERENCE TO RELATED APPLICATIONS

This application claims the benefit of U.S. Provisional Application No. 61/833,028 filed Jun. 10, 2013. This application is also a continuation-in-part of U.S. patent application Ser. No. 13/856,201 filed on Apr. 3, 2013 which claims priority from Provisional Application No. 61/766,016 filed on Feb. 18, 2013. This application is also a continuation-in-part (CIP) of U.S. patent application Ser. No. 13/624,397 filed on Sep. 21, 2012, now pending. The Ser. No. 13/624,397 Application is a continuation-in-part of:

(a) U.S. patent application Ser. No. 13/344,400 filed on Jan. 5, 2012, now pending, which is a continuation of U.S. patent application Ser. No. 12/434,221, filed May 1, 2009, now U.S. Pat. No. 8,112,376;

(b) U.S. patent application Ser. No. 12/195,863, filed Aug. 21, 2008, now U.S. Pat. No. 8,326,775, which claims priority under 35 USC 119 from Israeli Application No. 185414, filed on Aug. 21, 2007, and which is also a continuation-in-part of the below-referenced U.S. patent application Ser. No. 12/084,150; and,

(c) U.S. patent application Ser. No. 12/084,150 filed on Apr. 25, 2008, now U.S. Pat. No. 8,655,801, which is the National Stage of International Application No. PCT/IL2006/001235, filed on Oct. 26, 2006, which claims foreign priority from Israeli Application No. 171577 filed on Oct. 26, 2005 and Israeli Application No. 173409 filed on 29 Jan. 2006.

All of the applications referenced above are herein incorporated by reference for all that they contain.

### TECHNICAL FIELD

The present invention relates generally to the analysis of multimedia content, and more specifically to a system for providing recommendations to users based on their interaction with the multimedia content.

### BACKGROUND

With the abundance of data made available through various means in general and the Internet and world-wide web (WWW) in particular, a need to understand likes and dislikes of users has become essential for on-line businesses.

Prior art solutions provide several tools to identify users' preferences. Some prior art solutions actively require an input from the users to specify their interests. However, profiles generated for users based on their inputs may be inaccurate as the users tend to provide only their current interests, or only partial information due to their privacy concerns.

Other prior art solutions passively track the users' activity through particular web sites such as social networks. The disadvantage with such solutions is that typically limited information regarding the users is revealed, as users tend to provide only partial information due to privacy concerns. For example, users creating an account on Facebook® provide in most cases only the mandatory information required for the creation of the account.

It would therefore be advantageous to provide a solution that overcomes the deficiencies of the prior art by efficiently identifying preferences of users, and generating profiles thereof.

### SUMMARY

The embodiments disclosed herein include a method and system for providing recommendations to multimedia content elements of interest to a user. The method comprises receiving at least one multimedia content element; generating at least one signature for the received multimedia content element; querying a user profile of the user to determine a user interest; searching, by means of the at least one generated signature, through a plurality of data sources for multimedia content elements matching the determined user interest; and returning the matching multimedia content elements to the user node as recommendations.

### BRIEF DESCRIPTION OF THE DRAWINGS

The subject matter that is regarded disclosed herein is particularly pointed out and distinctly claimed in the claims at the conclusion of the specification. The foregoing and other objects, features, and advantages of the invention will be apparent from the following detailed description taken in conjunction with the accompanying drawings.

FIG. 1 is a schematic block diagram of a system utilized to describe the various embodiments disclosed herein.

FIG. 2 is a flowchart describing a method for profiling a user's interest and creating a user profile based on an analysis of multimedia content.

FIG. 3 is a flowchart describing a method for profiling a user's interest and creating a user profile based on an analysis of multimedia content according to another embodiment.

FIG. 4 is a block diagram depicting the basic flow of information in the signature generator system.

FIG. 5 is a diagram showing the flow of patches generation, response vector generation, and signature generation in a large-scale speech-to-text system.

FIG. 6 is a flowchart describing a method for providing recommendations for multimedia content elements to a user respective of the user's profile according to one embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

Certain exemplary embodiments disclosed herein utilize a database of users' profiles to provide recommendations for multimedia contents respective thereof. The database of users' profiles is created based on the users impression with respect to multimedia content elements and the respective signatures generated thereof. The user impression indicates the user's attention to a certain multimedia content or element. The multimedia content element viewed by the user is analyzed and one or more matching signatures are generated respective thereto. Based on the signatures, a concept or concepts of the multimedia content element is determined. Thereafter, based on the concept or concepts, the user preferences are determined, and user's profile respective thereto is created. The profile and impressions for each user are saved in a data warehouse or a database.

Thereafter, upon receiving a multimedia content element, such element is analyzed and at least one signature is generated respective thereto. Then, recommendations to one or more similar multimedia content elements respective of the signature and the user profile are provided to the user.

As a non-limiting example, if a user views and interacts with images of pets and the generated user's impression respective of all these images is positive, the user's profile may be determined as an “animal lover.” The profile of the user is then stored in the data warehouse for further use. Then, if the user viewed a cartoon video of Winnie the Pooh, the video of The Lion King animated movie may be recommended to the user based on the user's interest in animals.

A user impression may be determined, in part, by the period of time the user viewed or interacted with the multimedia content elements, a gesture received by the user node such as, a mouse click, a mouse scroll, a tap, and any other gesture on a device having, e.g., a touch screen display or a pointing device. According to another embodiment, a user impression may be determined based on matching between a plurality of multimedia content elements viewed by a user and their respective impression. According to yet another embodiment, a user impression may be generated based on multimedia content elements that the user uploads or shares on the web, such as social networking websites. It should be noted that the user impression may be determined based on one or more of the above identified techniques.

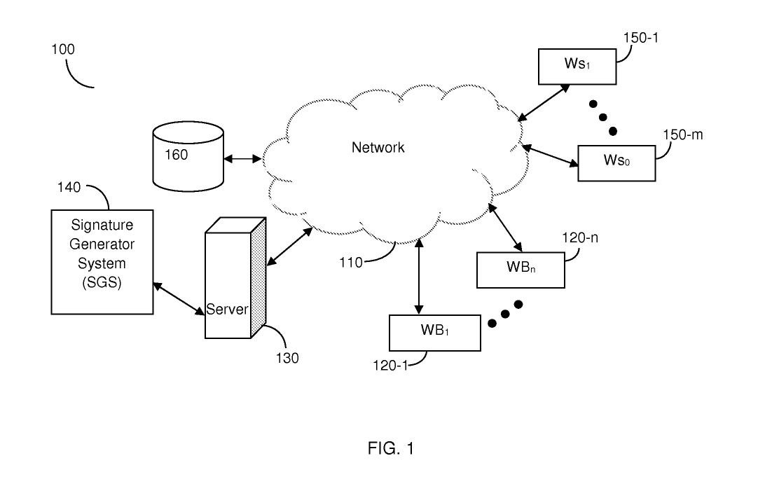

FIG. 1 shows an exemplary and non-limiting schematic diagram of a system 100 utilized to describe the various embodiments disclosed herein. As illustrated in FIG. 1, a network 110 enables the communication between different parts of the system. The network 110 may be the Internet, the world-wide-web (WWW), a local area network (LAN), a wide area network (WAN), a metro area network (MAN), and other networks capable of enabling communication between the elements of the system 100.

Further connected to the network 110 are client applications, such as web browsers (WB) 120-1 through 120-n (collectively referred to hereinafter as web browsers 120 or individually as a web browser 120). A web browser 120 is executed over a computing device (or a user node) which may be, for example, a personal computer (PC), a personal digital assistant (PDA), a mobile phone, a tablet computer, a smart phone, a wearable computing device, and the like.

The computing device is configured to at least provide multimedia elements to servers connected to the network 110. According to one embodiment, each web browser 120 is installed with an add-on or is configured to embed an executable script (e.g., Java script) in a web page rendered on the browser 120. The executable script is downloaded from the server 130 or any of the web sources 150. The add-on and the script are collectively referred to as a “tracking agent,” which is configured to track the user's impression with respect to multimedia content viewed by the user on a browser 120 or uploaded by the user through a browser 120.

The content displayed on a web browser 120 may be downloaded from a web source 150 and/or may be embedded in a web-page. The uploaded multimedia content element can be locally saved in the computing device or can be captured by the device. For example, the multimedia content element may be an image captured by a camera installed in the client device, a video clip saved in the device, and so on. A multimedia content element may be, for example, an image, a graphic, a video stream, a video clip, an audio stream, an audio clip, a video frame, a photograph, an image of signals (e.g., spectrograms, phasograms, scalograms, etc.), combinations thereof and/or portions thereof.

The system 100 also includes a plurality of web sources 150-1 through 150-m (collectively referred to hereinafter as web sources 150 or individually as a web sources 150) connected to the network 110. Each of the web sources 150 may be, for example, a web server, an application server, a data repository, a database, and the like.

The various embodiments disclosed herein may be realized using the profiling server 130 and a signature generator system (SGS) 140. The profiling server 130 is configured to create a profile for each user of a web browser 120 as will be discussed below.

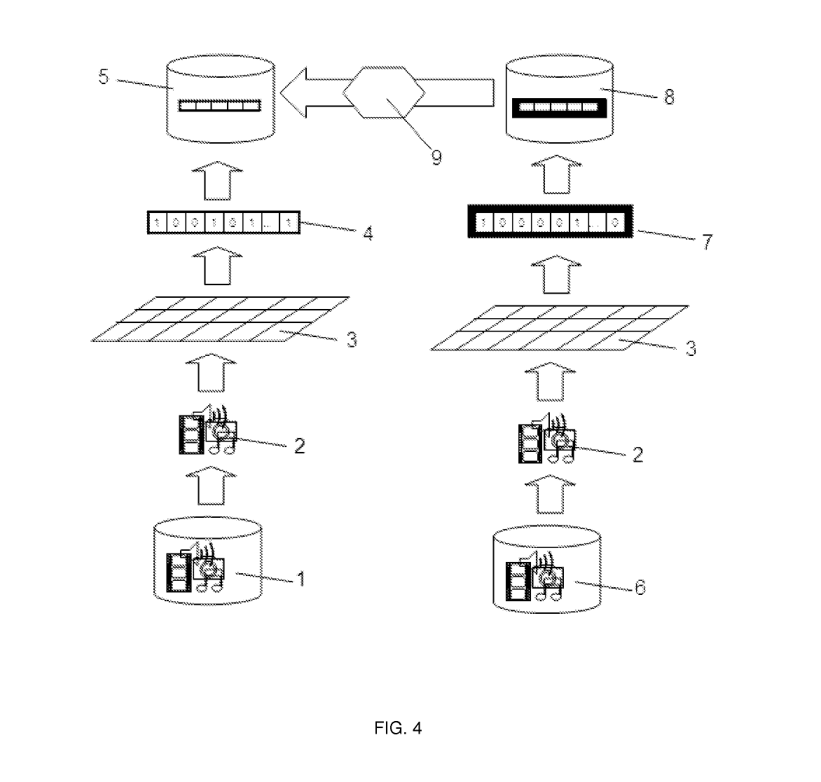

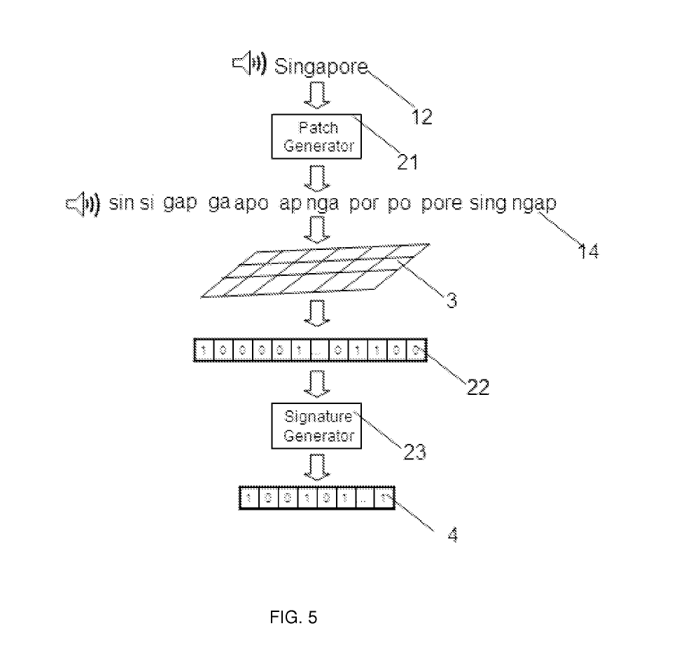

The SGS 140 is configured to generate a signature respective of the multimedia elements or content fed by the profiling server 130. The process for generating the signatures is explained in more detail herein below with respect to FIGS. 4 and 5. Each of the profiling server 130 and the SGS 140 typically is comprised of a processing unit, such as a processor (not shown) that is coupled to a memory. The memory typically contains instructions that can be executed by the processing unit. The profiling server 130 also includes an interface (not shown) to the network 110. In an embodiment, the SGS 140 can be integrated in the server 130. In an embodiment, the server 130 and/or the SGS 140 may include a plurality of computational cores having properties that are at least partly statistically independent from other of the plurality of computational cores. The computational cores are further discussed below.

A tracking agent or other means for collection information through the web browser 120 may be configured to provide the profiling server 130 with tracking information related to the multimedia element viewed or uploaded by the user and the interaction of the user with the multimedia element. The information may include, but is not limited to, the multimedia element (or a URL referencing the element), the amount of time the user viewed the multimedia element, the user's gesture with respect to the multimedia element, a URL of a webpage that the element was viewed or uploaded to, and so on. The tracking information is provided for each multimedia element displayed on a user's web browser 120.

The server 130 is then configured to determine the user impression with respect to the received tracking information. The user impression may be determined per each multimedia element or for a group of elements. As noted above, the user impression indicates the user attention with respect to a multimedia content element. In one embodiment, the server 130 may first filter the tracking information to remove details that cannot help in the determination of the user impression. A user impression may be determined by, e.g., a user's click on an element, a scroll, hovering over an element with a mouse, change in volume, one or more key strokes, and so on. These impressions may further be determined to be either positive (i.e., demonstrating that a user is interested in the impressed element) or negative (i.e., demonstrating that a user is not particularly interested in the impressed element). According to one embodiment, a filtering operation may be performed in order to analyze only meaningful impressions. Impressions may be determined as meaning measures and thereby ignored, e.g., if they fall under a predefined threshold.

For example, in an embodiment, if the user hovered over the element using his mouse for a very short time (e.g., less than 0.5 seconds), then such a measure is ignored. The server 130 is then configured to compute a quantitative measure for the impression. In one embodiment, for each input measure that is tracked by the tracking agent a predefined number is assigned. For example, a dwell time over the multimedia element of 2 seconds or less may be assigned with a ‘5’; whereas a dwell time of over 2 seconds may be assigned with the number ‘10’. A click on the element may increase the value of the quantitative measure by assigning another quantitative measure of the impression. After one or more input measures of the impression have been made, the numbers related to the input measures provided in the tracking information are accumulated. The total of these input measures is the quantitative measure of the impression. Thereafter, the server compares the quantitative measure to a predefined threshold, and if the number exceeds the threshold the impression is determined to positive.

For example, in an embodiment, if a user hovers over the multimedia element for less than 2 seconds but then clicks on the element, the score may be increased from 5 to 9 (i.e., the click may add 4 to the total number). In that example, if a user hovers over the multimedia element for more than 2 seconds and then clicks on the element, the score may be increased from 10 to 14. In some embodiments, the increase in score may be performed relative to the initial size of the score such that, e.g., a score of 5 will be increased less (for example, by 2) than a score of 10 would be increased (for example, by 4).

The multimedia element or elements that are determined as having a positive user impression are sent to the SGS 140. The SGS 140 is then configured to generate at least one signature for each multimedia element or each portion thereof. The generated signature(s) may be robust to noise and distortions as discussed below.

It should be appreciated that signatures may be used for profiling the user's interests, because signatures allow more accurate reorganization of multimedia elements in comparison than, for example, utilization of metadata. The signatures generated by the SGS 140 for the multimedia elements allow for recognition and classification of multimedia elements such as content-tracking, video filtering, multimedia taxonomy generation, video fingerprinting, speech-to-text, audio classification, element recognition, video/image search and any other application requiring content-based signatures generation and matching for large content volumes such as, web and other large-scale databases. For example, a signature generated by the SGS 140 for a picture showing a car enables accurate recognition of the model of the car from any angle at which the picture was taken.

In one embodiment, the generated signatures are matched against a database of concepts (not shown) to identify a concept that can be associated with the signature, and hence the multimedia element. For example, an image of a tulip would be associated with a concept structure of flowers. The techniques for generating concepts, concept structures, and a concept-based database are disclosed in a co-pending U.S. patent application Ser. No. 13/766,463, filed on Feb. 13, 2013, assigned to common assignee, which is hereby incorporated by reference for all the useful information it contains.

The profiling server 130 creates the user profile using the identified concepts. That is, for each user, when a number of similar or identical concepts for multiple multimedia elements have been identified over time, the user's preference or interest can be established. The interest may be saved to a user profile created for the user. Whether two concepts are sufficiently similar or identical may be determined, e.g., by performing concept matching between the concepts. A concept (or a matching concept) is a collection of signatures representing a multimedia element and metadata describing the concept. The collection of signatures is a signature reduced cluster generated by inter-matching signatures generated for the plurality of multimedia elements. The matching concept is represented using at least one signature. Techniques for concept matching are disclosed in U.S. patent application Ser. No. 14/096,901, filed on Dec. 4, 2013, assigned to common assignee, which is hereby incorporated by reference for all the useful information it contains.

For example, a concept of flowers may be determined as associated with a user interest in towers' or ‘gardening.’ In one embodiment, the user interest may simply be the identified concept. In another embodiment the interest may be determined using an association table which associates one or more identified concepts with a user interest. For example, the concept of ‘flowers’ and ‘spring’ may be associated with the interest of ‘gardening’. Such an association table may be maintained in the profiling server 130 or the data warehouse 160.

According to the disclosed embodiment, the profiling sever 130 is further configured to provide recommendations of multimedia content elements of interest to the user. Accordingly, upon receiving a multimedia content element from the browser 120 of a user, at least one signature is generated for the received element. Then, a user profile of the user is queried to determine the interest or interests of the user. The server is then configured to search using the at least one generated signature through web sources for multimedia content elements matching the determined user interests. The content elements determined to match the user interest are sent to the web browser on the user device as recommendations.

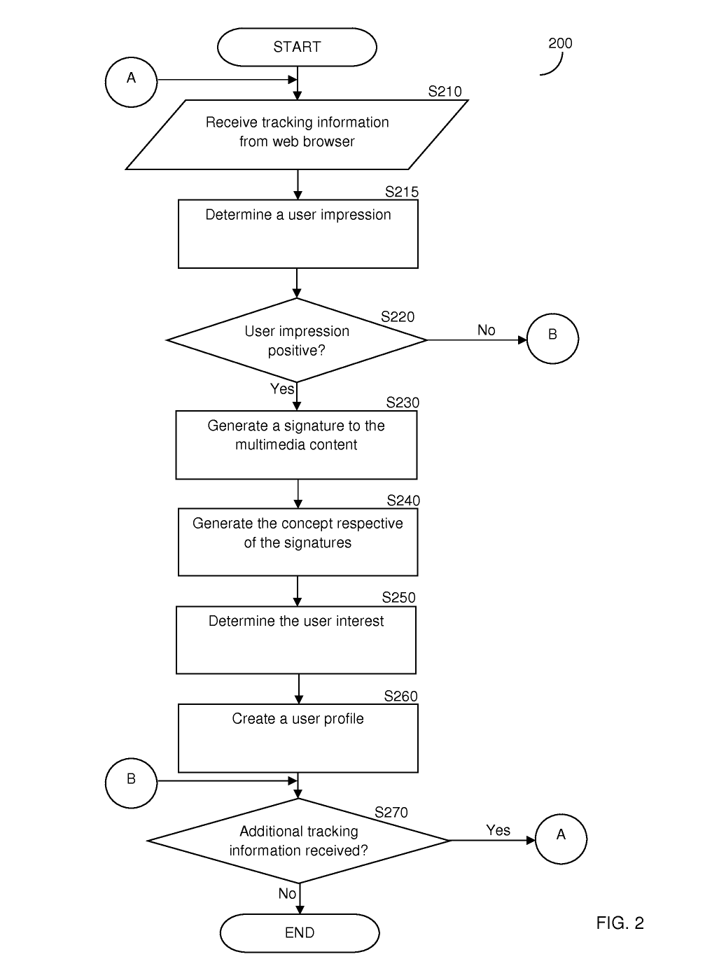

FIG. 2 depicts an exemplary and non-limiting flowchart 200 describing the process of creating users' profiles based on an analysis of multimedia content elements according to one embodiment. It should be noted that, in this embodiment, tracking information is collected by a web browser. In various embodiments, tracking information may be collected from other sources such as, e.g., a database. In S210, the tracking information collected by one of the web-browsers (e.g., web-browser 120-1) is received. In an embodiment, the tracking information is received at the profiling server 130. As noted above, the tracking information is collected with respect to multimedia elements displayed over the web browser.

In S215, a user impression is determined based on the received tracking information. One embodiment for determining the user impression is described above. The user impression is determined for one or more multimedia elements identified in the tracking information. In S220, it is checked if the user impression is positive, and if so execution continues with S230; otherwise, execution proceeds with S270. Whether a user impression is positive is discussed further herein above with respect to FIG. 1.

In S230, at least one signature to each of the multimedia elements identified in the tracking information is generated. As noted above, the tracking information may include the actual multimedia element(s) or a link thereto. In the latter case, each of the multimedia element(s) is first retrieved from its location. The at least one signature for each multimedia element may be generated by the SGS 140 as described below. In S240, the concept respective of the signature generated for the multimedia element is determined. In one embodiment, S240 includes querying a concept-based database using the generated signatures. In S250, the user interest is determined by, e.g., the server 130 respective of the concept or concepts associated with the identified elements.

One embodiment for determining the user interest is described below. As a non-limiting example, the user views a web-page that contains an image of a car. The image is then analyzed and a signature is generated respective thereto. As it appears that the user spent time above a certain threshold viewing the image of the car, the user's impression is determined as positive. It is therefore determined that the user's interest is cars.

In S260, a user profile is created in the data warehouse 160 and the determined user interest is saved therein. It should be noted that if a user profile already exists in the data warehouse 160, the receptive user profile is only updated to include the user interest determined in S250 rather than being both created and updated. It should be noted that a unique profile is created for each user of a web browser. The user may be identified by a unique identification number assigned, for example, by the tracking agent. The unique identification number typically does not reveal the user's identity. The user profile can be updated over time as additional tracking information is gathered and analyzed by the profiling server. In one embodiment, the server 130 analyzes the tracking information only when a sufficient amount of information has been collected. In S270, it is checked whether additional tracking information is received and, if so, execution continues with S210; otherwise, execution terminates.

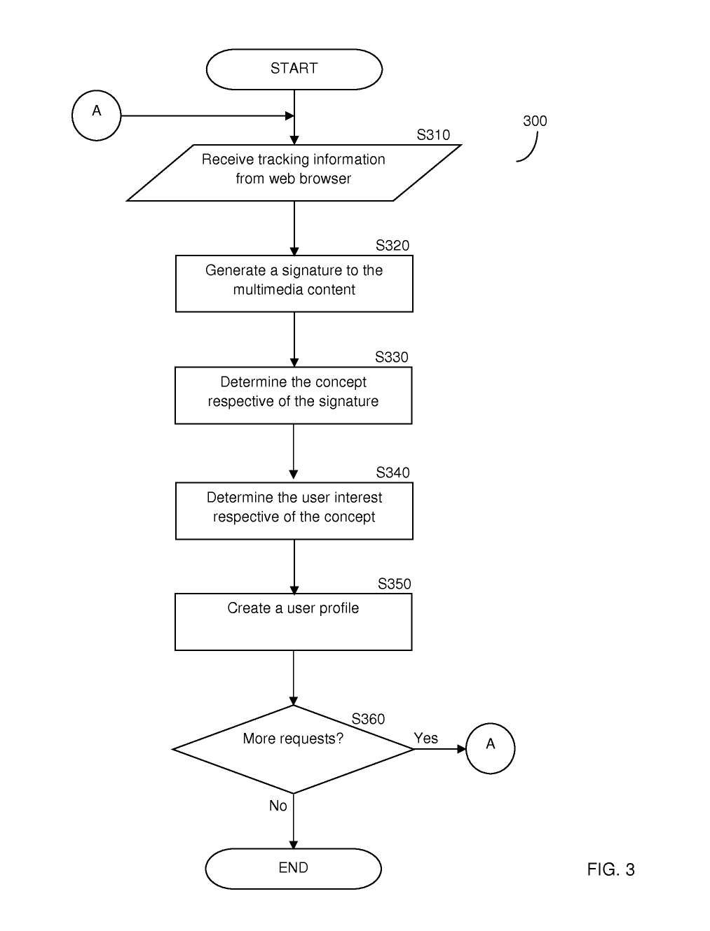

FIG. 3 depicts an exemplary and non-limiting flowchart 300 describing the process for profiling a user interest and creating a user profile based on an analysis of multimedia content elements according to another embodiment. In S310, tracking information gathered by the tracking agent is received. In an embodiment, such tracking information is received at the server 130. According to this embodiment, the tracking information identifies multimedia elements (e.g., pictures, video clips, etc.) uploaded by the user from a web-browser 120 to one or more information sources. The information sources may include, but are not limited to, social networks, web blogs, news feeds, and the like. The social networks may include, for example, Google+®, Facebook®, Twitter®, Instagram, and so on. The tracking information includes the actual uploaded content or a reference thereto. This information may also contain the name of each of the information sources, text entered by the user with the uploaded image, and a unique identification code assigned to a user of the web browser.

In S320, at least one signature for each multimedia element identified in the tracking is generated. The signatures for the multimedia content elements are typically generated by a SGS 140 as described hereinabove. In S330, the concept respective of the at least one signature generated for each multimedia element is determined. In one embodiment, S330 includes querying a concept-based database using the generated signatures. In S340, the user interest is determined by the server 130 respective of the concept or concepts associated with the identified elements. According to one embodiment, if text is entered by the user and if such text is included in the tracking information, the input text is also processed by the server 130 to provide an indication if the element described a favorable interest.

In S350, a user profile is created in the data warehouse 150 and the determined user interest is saved therein. It should be noted that if a user profile already exists in the data warehouse 160, the receptive user profile is only updated to include the user interest determined in S340. In S360, it is checked whether there are additional requests, and if so, execution continues with S310; otherwise, execution terminates.

As a non-limiting example for the process described in FIG. 3, a picture of a user riding a bicycle is uploaded to the user's profile page in Facebook®. The image is then analyzed and a signature is generated respective thereto. A comment made by the user stating: “I love those field trips” is identified. Based on analysis of the concept of the uploaded picture and the user's comment, the user profile is determined as positive for field trips. The user profile is then stored or updated (if, e.g., the user profile already existed prior to this example) in a data warehouse for further use.

According to one embodiment, in such cases where several elements are identified in the tracking information, a signature is generated for each of these elements and the context of the multimedia content (i.e., collection of elements) is determined respective thereto. An exemplary technique for determining a context of multimedia elements based on signatures is described in detail in U.S. patent application Ser. No. 13/770,603, filed on Feb. 19, 2013, assigned to common assignee, which is hereby incorporated by reference for all the useful information it contains.

FIGS. 4 and 5 illustrate the generation of signatures for the multimedia elements by the SGS 140 according to one embodiment. An exemplary high-level description of the process for large scale matching is depicted in FIG. 4. In this example, the matching is for a video content.

Video content segments 2 from a Master database (DB) 6 and a Target DB 1 are processed in parallel by a large number of independent computational Cores 3 that constitute an architecture for generating the Signatures (hereinafter the “Architecture”). Further details on the computational Cores generation are provided below. The independent Cores 3 generate a database of Robust Signatures and Signatures 4 for Target content-segments 5 and a database of Robust Signatures and Signatures 7 for Master content-segments 8. An exemplary and non-limiting process of signature generation for an audio component is shown in detail in FIG. 5. Finally, Target Robust Signatures and/or Signatures are effectively matched, by a matching algorithm 9, to Master Robust Signatures and/or Signatures database to find all matches between the two databases.

To demonstrate an example of signature generation process, it is assumed, merely for the sake of simplicity and without limitation on the generality of the disclosed embodiments, that the signatures are based on a single frame, leading to certain simplification of the computational cores generation. The Matching System is extensible for signatures generation capturing the dynamics in-between the frames.

The Signatures' generation process is now described with reference to FIG. 5. The first step in the process of signatures generation from a given speech-segment is to break down the speech-segment to K patches 14 of random length P and random position within the speech segment 12. The breakdown is performed by the patch generator component 21. The value of the number of patches K, random length P and random position parameters is determined based on optimization, considering the tradeoff between accuracy rate and the number of fast matches required in the flow process of the profiling server 130 and SGS 140. Thereafter, all the K patches are injected in parallel into all computational Cores 3 to generate K response vectors 22, which are fed into a signature generator system 23 to produce a database of Robust Signatures and Signatures 4.

In order to generate Robust Signatures, i.e., Signatures that are robust to additive noise L (where L is an integer equal to or greater than 1) by the Computational Cores 3, a frame ‘i’ is injected into all the Cores 3. Then, Cores 3 generate two binary response vectors: \vec{S} which is a Signature vector, and \vec{RS} which is a Robust Signature vector.

For generation of signatures robust to additive noise, such as White-Gaussian-Noise, scratch, etc., but not robust to distortions, such as crop, shift and rotation, etc., a core Ci={ni} (1≦i≦L) may consist of a single leaky integrate-to-threshold unit (LTU) node or more nodes. The node ni equations are:

$${V}_{i} = {\sum }_{j} {w}_{ij} {k}_{j}$$

$$ni = ( Vi - Thx )$$

where, is a Heaviside step function; wij is a coupling node unit (CNU) between node i and image component j (for example, grayscale value of a certain pixel j); kj is an image component ‘j’ (for example, grayscale value of a certain pixel j); Thx is a constant Threshold value, where x is ‘S’ for Signature and ‘RS’ for Robust Signature; and Vi is a Coupling Node Value.

The Threshold values ThX are set differently for Signature generation and for Robust Signature generation. For example, for a certain distribution of values (for the set of nodes), the thresholds for Signature (ThS) and Robust Signature (ThRS) are set apart, after optimization, according to at least one or more of the following criteria:

For: Vᵢ>Th_{RS} 1:

1−p(V>Th_{S})−1−(1−ε)^{l}<<1

i.e., given that I nodes (cores) constitute a Robust Signature of a certain image I, the probability that not all of these I nodes will belong to the Signature of a same, but noisy image, Ĩ is sufficiently low (according to a system's specified accuracy).

p(Vᵢ>Th_{RS})≈l/L 2:

i.e., approximately I out of the total L nodes can be found to generate a Robust Signature according to the above definition.
3: Both Robust Signature and Signature are generated for certain frame i.

It should be understood that the generation of a signature is unidirectional, and typically yields lossless compression, where the characteristics of the compressed data are maintained but the uncompressed data cannot be reconstructed. Therefore, a signature can be used for the purpose of comparison to another signature without the need of comparison to the original data. The detailed description of the Signature generation can be found U.S. Pat. Nos. 8,326,775 and 8,312,031, assigned to common assignee, and are hereby incorporated by reference for all the useful information they contain.

A Computational Core generation is a process of definition, selection, and tuning of the parameters of the cores for a certain realization in a specific system and application. The process is based on several design considerations, such as:

(a) The Cores should be designed so as to obtain maximal independence, i.e., the projection from a signal space should generate a maximal pair-wise distance between any two cores' projections into a high-dimensional space.

(b) The Cores should be optimally designed for the type of signals, i.e., the Cores should be maximally sensitive to the spatio-temporal structure of the injected signal, for example, and in particular, sensitive to local correlations in time and space. Thus, in some cases a core represents a dynamic system, such as in state space, phase space, edge of chaos, etc., which is uniquely used herein to exploit their maximal computational power.

(c) The Cores should be optimally designed with regard to invariance to a set of signal distortions, of interest in relevant applications.

Detailed description of the Computational Core generation and the process for configuring such cores is discussed in more detail in the U.S. Pat. No. 8,655,801 referenced above.

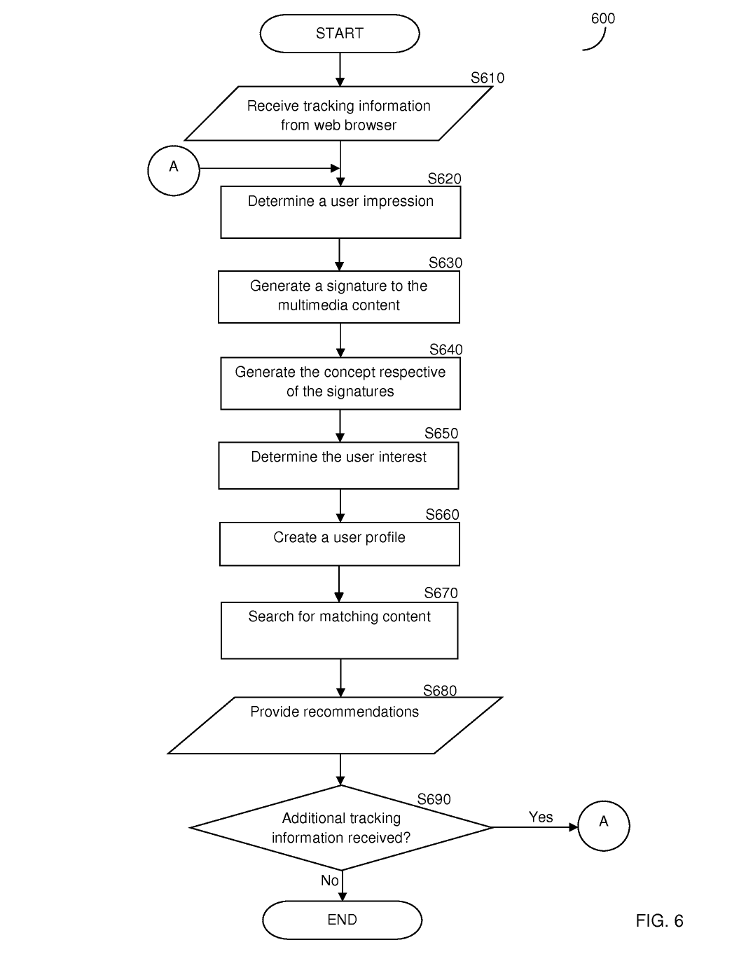

FIG. 6 depicts an exemplary and non-limiting flowchart 600 describing the process of providing recommendations to users respective of the users' profiles based on an analysis of multimedia content elements according to one embodiment. It should be noted that, in various embodiments, recommendations may be provided without first receiving multimedia content elements to analyze. In such embodiments, recommendations may be determined and provided in response to, e.g., a predetermined event, input from a user, and so on. As a non-limiting example, a user may request a recommendation for a movie or TV show to watch on a video streaming content website based on his or her interests.

In S610, the tracking information collected by one of the web-browsers 120 is received. In an embodiment, this tracking information is received at the server 130. In S620, a user impression is determined based on the received tracking information as further described hereinabove. The user impression is determined for one or more multimedia elements identified in the tracking information. In S630, l at least one signature to each of the multimedia elements identified in the tracking information is generated. In an embodiment, the at least one signature for each multimedia element is generated by the SGS 140 as described above with respect of FIGS. 4 and 5.

In S640, the concept respective of the signature generated for the multimedia element is determined. In S650, the user interest is determined respective of the concept or concepts associated with the identified elements. One embodiment for determining the user interest is described above. In S660, a user profile and the determined user interest is saved therein. It should be noted that if a user profile already exists, the respective user profile is only updated to include the user interest(s) determined in S650.

In S670, a search for content that matches the user interest or interests in order to provide such content to the user device is performed. The matching may be made to the user's profile, the at least one signature generated for each of the one or more identified multimedia elements, and/or combinations thereof.

Matching during the search may include performing signature matching as discussed further herein above between the signature of a tracked element and the signatures of one or more multimedia content elements and/or concept structures. The search is performed through one or more data sources. Such data sources may include web source 150, the database 160, and combinations thereof.

In S680, one or more links to the matching content elements are provided to the user as recommendations. The recommendations may include the actual multimedia element(s) or a link thereto. In an embodiment, a link to a multimedia content element is sent as a recommendation only if the signature of the multimedia content element sufficiently matches the signature of tracked multimedia content element. In S690, it is checked whether additional tracking information has been received, and if so, execution continues with S620; otherwise, execution terminates.

In an alternative embodiment, a user node, such as a personal computer, a smartphone, a tablet computer or a wearable computing device, can be adapted to perform the method for providing recommendations to users respective of the users' profiles based on an analysis of multimedia content element as discussed herein above.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for providing recommendations to multimedia content elements of interest to a user, comprising:
receiving at least one multimedia content element;
generating at least one signature for the received multimedia content element;
querying a user profile of the user to determine a user interest;
searching, by means of the at least one generated signature, through a plurality of data sources for multimedia content elements matching the determined user interest; and
returning the matching multimedia content elements to the user node as recommendations.

2. The method of claim 1, further comprising:
determining a concept of the at least one multimedia element using the at least one generated signature; and
searching, based on the determined concept, through a plurality of data sources for multimedia content elements matching the determined user interest.

3. The method of claim 2, further comprising:
generating the user profile by receiving tracking information gathered with respect to an interaction of the user with multimedia element elements displayed on the user node of the user;
determining a user impression respective of the multimedia content elements using the received tracking information;
generating at least one signature for the multimedia content element;
determining a concept respective of the generated signatures, wherein an interest of the user is determined respective of the concept; and
saving the determined interest in a user profile associated with the user of the user node.

4. The method of claim 3, further comprising updating the user profile using at least one of: the concept determined for the received least one multimedia content element, and the signature.

5. The method of claim 3, wherein the tracking information further includes at least one of: a measure of a period of time the user viewed the multimedia element, an indication of a user's gesture detected over the multimedia element, an indication of whether the at least one multimedia element was uploaded to an information source, an identification of the information source, and a unique identification code identifying the user.

6. The method of claim 5, wherein the user gesture is any one of: a scroll over the at least one multimedia element, a click on the at least one multimedia element, a tap on the at least one multimedia element, and a response to the at least one multimedia element.

7. The method of claim 3, wherein generating the user impression respective of the at least one multimedia content element further comprising:
filtering the tracking information to remove meaningless measures;
assigning a number for each meaningful measure and indication in the tracking information; and
computing a quantitative measure for the user impression as a summation of the assigned numbers.

8. The method of claim 7, further comprising:
determining if the user impression is positive; and
generating at least one signature if the at least one multimedia element is associated with a positive user impression.

9. The method of claim 5, wherein the determination of the user interest respective of the concept is performed using an association table that maps one or more identified concepts to a user interest.

10. The method of claim 1, wherein the concept is determined by querying a concept-based database using the at least one signature.

11. The method of claim 1, wherein the at least one signature is robust to noise and distortion.

12. The method of claim 1, wherein a multimedia content element is at least one of: an image, graphics, a video stream, a video clip, an audio stream, an audio clip, a video frame, a photograph, images of signals, combinations thereof, and portions thereof.

13. The method of claim 12, further comprising:
storing the one or more matching content elements in the data warehouse for further use.

14. The method of claim 1, wherein the concept is a collection of signatures representing one or more multimedia content elements and metadata describing the concept, the collection of signatures is a signature reduced cluster generated by inter-matching signatures generated for the one or more multimedia elements.

15. A non-transitory computer readable medium having stored thereon instructions for causing one or more processing units to execute the method according to claim 1.

16. A system for profiling interests of users based on multimedia content analysis and providing recommendations respective thereof, comprising:
an interface to a network for at least receiving tracking information gathered with respect to an interaction of a user with at least one multimedia element displayed on a user node of the user;
a processor; and
a memory, wherein the memory contains instructions that, when executed by the processor, configure the system to:
receive at least one multimedia content element;
generate at least one signature for the received multimedia content element;
query a user profile of the user to determine a user interest;
search, by means of the at least one generated signature, through a plurality of data sources for multimedia content elements matching the determined user interest; and
return the matching multimedia content elements to the user node as recommendations.

17. The system of claim 16, wherein the system is further configured to generate the at least one signature for the at least one multimedia element, wherein the at least one signature is robust to noise and distortion.

18. The system of claim 16, further configured to:
generate the user profile by receiving tracking information gathered with respect to an interaction of the user with multimedia element elements displayed on the user node of the user;
determine a user impression respective of the multimedia content elements using the received tracking information;
generate at least one signature for the multimedia content element;
determine a concept respective of the generated signatures, wherein an interest of the user is determined respective of the concept; and
saving the determined interest in a user profile associated with the user of the user node.

19. The system of claim 18, wherein the tracking information includes any one of: the at least one multimedia element, and a reference to the at least one multimedia element.

20. The system of claim 19, wherein the tracking information further includes at least one of: a measure of a period of time the user viewed the multimedia element, an indication of a user's gesture detected over the multimedia element, an indication of whether the at least one multimedia element was uploaded to an information source, an identification of the information source, and a unique identification code identifying the user.

21. The system of claim 20, wherein the system is further configured to:
filter the tracking information to remove meaningless measures;
assign a number for each meaningful measure and indication in the tracking information; and
compute a quantitative measure for the user impression as a summation of the assigned numbers.

22. The system of claim 21, wherein the system is further configured to:
determine if the user impression is positive; and
generate at least one signature if the at least one multimedia element is associated with a positive user impression.

23. The system of claim 21, wherein the system is further configured to:
provide the one or more matching multimedia content elements to the user node.

24. The system of claim 22, wherein the matching content elements are provided to the user node as recommendations.
